(19) United States
(12) Patent Application Publication
(10) Pub. No.: US 2010/0032469 A1
(43) Pub. Date: Feb. 11, 2010

(54) STAPLER WITH INTEGRATED PAPER CLIP HOLDER

(76) Inventor: Jeff Baker, Orlando, FL (US)

Correspondence Address: Beusse Wolter Sanks Mora & Maire, 390 N. ORANGE AVENUE, SUITE 2500, ORLANDO, FL, 32801, US

(21) Appl. No.: 12/496,604

(22) Filed: Jul. 1, 2009

Related U.S. Application Data
(60) Provisional application No. 61/077,346, filed on Jul. 1, 2008.

(51) Int. Cl. B25C 5/00; B25C 7/00

(52) U.S. Cl. 227/156

(57) ABSTRACT

A stapler 10 that has a first arm 12 having a proximal end 13 and a distal end 15 and a second arm 14 having a proximal end 17 and a distal end 19. The first arm 12 and second arm 14 are pivotably connected at said proximal ends 13, 17. As shown, the proximal ends 13, 17 associate with a connecting spacer 16. The connecting spacer 16 defines a void 21 having free access to one or both sides of the stapler 10. Furthermore, the connecting spacer 16 includes a magnet 20 disposed within the spacer 16. Magnetizable items such as paper clips 18 may be stored in the void 21 and are secured by attraction to the magnet. Also disclosed is a stapler wherein the first arm 12, second arm 14 and connecting spacer form generally a “lambda” shape with the apex of the lambda, as shown pertaining to the spacer 16, leaning to the side. This gives the impression that the stapler should topple over or the impressive effect of a stapler balancing on one end.

### CROSS REFERENCE TO RELATED APPLICATIONS

This application is related to U.S. Provisional Application No. 61/077,346 filed Jul. 1, 2008, to which priority is claimed herein under 35 USC 119.

### BACKGROUND

In the field of office supplies and desk equipment, there are very few innovations created which assist an office worker in organizing different types of supplies.

U.S. Patent No. 3,987,951, pertains to a stapler having a pair of elongated members pivotally interconnected at first ends thereof by a hinge pin so that the opposite ends of the members can move toward and away from each other to effect a stapling operation. One of the members carries an anvil at its opposite end and the other member has means at the opposite end for dispensing staples through sheet material and against the anvil when the members are squeezed together by the hand after the sheet has been placed between the members. Such dispensing means includes a pair of relatively shiftable elements including a ram for dislodging and driving the end staple of a group of staples through an opening in one of the elements and toward the anvil. The members are provided with leg means on the lower ends thereof for positioning the stapler on a supporting surface in an upright, stabilized position so that the members can be grasped by the hand and moved together when the hand is squeezed.

U.S. Pat. No. 4,114,793 pertains to a multi-purpose stapler is provided comprising a stapling means, a staple removing means and a hole punching means with shiftable actuator mounted on a common base. An actuator is provided which is movable between first and second positions. In the first position of the actuator, downward movement of a press handle of the stapler is limited so that stapling cannot occur but punching and staple removing can occur. In the second position of the actuator stapling can occur. The actuator functions to depress a punch rod when in its first position.

U.S. Pat. No. 4,830,256 pertains to a stapling system with a power driven stapler unit for stapling sheets together by clamping the sheets together with a clamper and driving a staple into the sheets with a staple driver while the sheets are clamped, and clinching the legs of the staple with a clincher, sequentially in that order; a single flexible cable with internal bights thereof operatively connecting with the clamper, the staple driver and the clincher, and with a free portion of the cable extending from the stapler unit and pulled with increasing movement and tension to provide the sole actuating power for the stapler unit wherein sequentially coupling pulleys engaged by the internal bights of the single flexible cable, and movement stops and/or resistance springs of different resistance forces, respectively operatively associated with the clamper, the staple driver and the clincher actuate them in that order, and wherein paired pulleys are arranged to multiply the forces available for the stapling from the cable tension.

U.S. Pat. No. 4,619,392 pertains to stapler comprising a storage area disposed in a base thereof for loading staples and paper clips, a closing base plate member having a window for checking on the supply of staples which is mounted to the base pivotally and closed in the base member to hold the staples within the storage area and a magnetic plate disposed at the other end portion of the base for retaining surplus paper clips within the base of the stapler.

### BRIEF DESCRIPTION OF THE DRAWINGS

FIG. 1 pertains to a side perspective of a stapler embodiment that has magnet means removed.

FIG. 2 pertains to a end view (a), top view (b), side view (c), bottom view (d) perspective view (e) and end view (f) opposite (a). The side of the embodiment shown in (c) mirrors that shown in (c).

### DETAILED DESCRIPTION

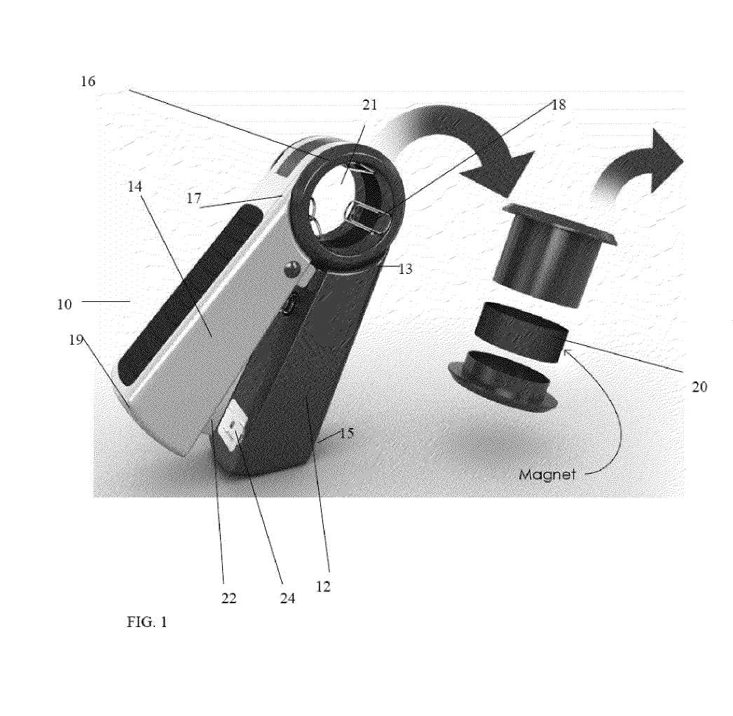

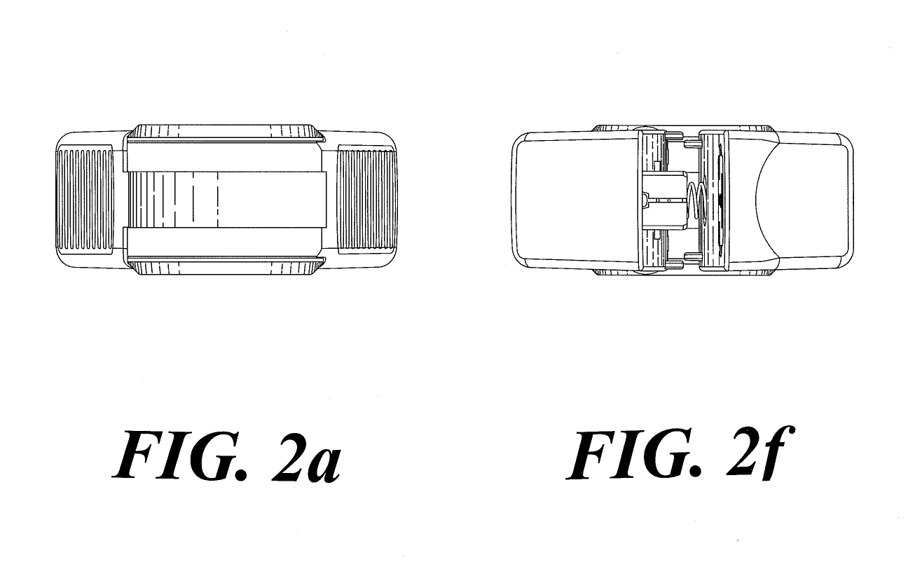

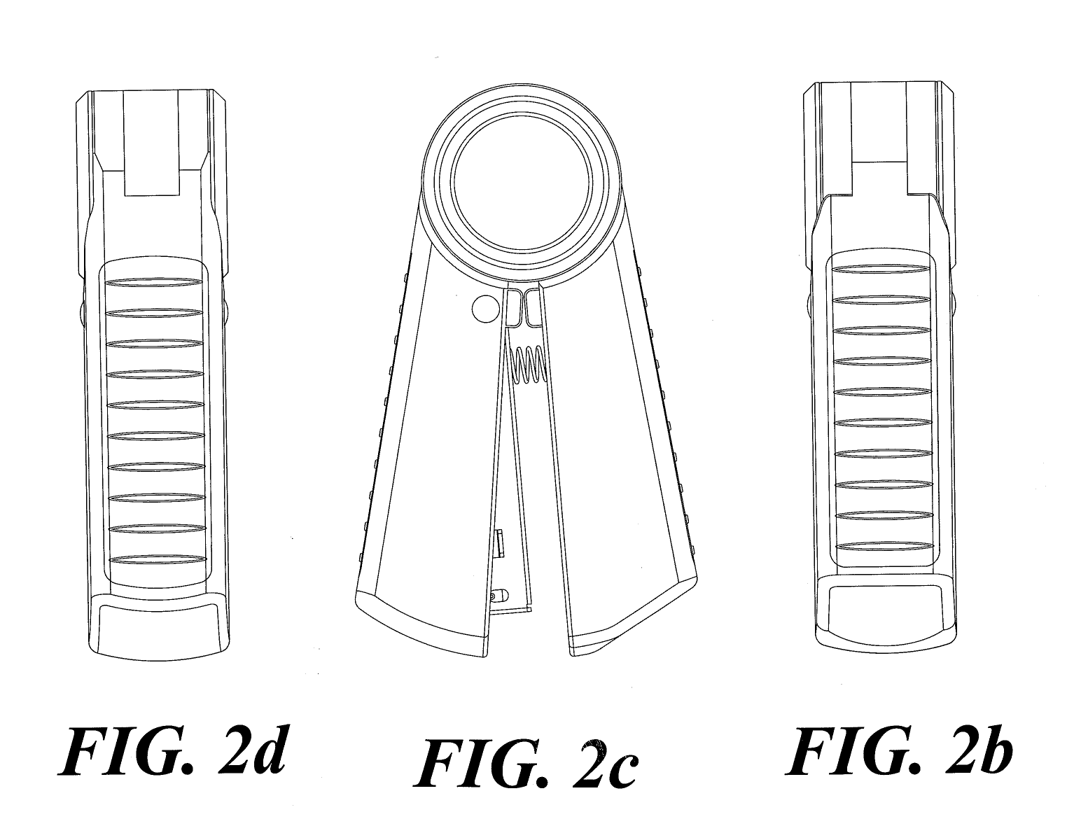

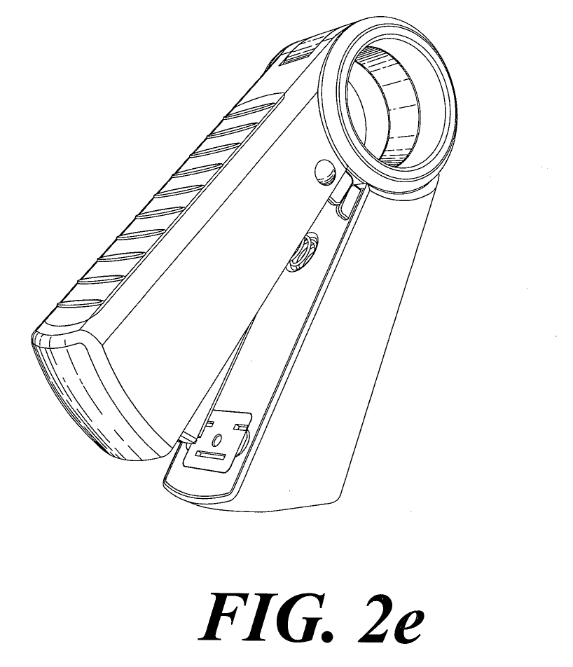

With reference to FIG. 1, according to one embodiment, the invention pertains to a stapler 10 that has a first arm 12 having a proximal end 13 and a distal end 15 and a second arm 14 having a proximal end 17 and a distal end 19. The first arm 12 and second arm 14 are pivotably connected at said proximal ends 13, 17. As shown, the proximal ends 13, 17 associate with a connecting spacer 16. The connecting spacer 16 defines a void 21 having free access to one or both sides of the stapler 10. Furthermore, the connecting spacer 16 includes a magnet 20 disposed within the spacer 16. Magnetizable items such as paper clips 18 may be stored in the void 21 and are secured by attraction to the magnet. Those skilled in the art will appreciate that that spacer 16 and void 21 can take one of many shapes such as, but not limited to, a circle (as shown), triangle, oval, hexagon, square or rectangle. The void may comprise an opening that communicates with both sides of the stapler (as shown) or an opening that only communicates with one side of the stapler.

The stapler embodiment 10 may also include one arm that has a depository 22 to store a multiplicity of staples (not shown). The stapler 10 is configured so that the arm 14 storing the staples dispenses a staple and closes the staple on a staple pad 24 provided on arm 12 when the arm 12, 14 are brought together. Furthermore, the stapler 10 is configured such that it balances on one of the distal ends of the arms. This provides an interesting and unique visual effect. The first arm 12, second arm 14 and connecting spacer form generally a “lambda” shape with the apex of the lambda, as shown pertaining to the spacer 16, leaning to the side. This gives the impression that the stapler should topple over or the impressive effect of a stapler balancing on one end. According to an alternative embodiment, the stapler does not comprise a connecting spacer but is configured to balance on the distal end of one or both arms.

In view of the foregoing, one can recognize that the subject matter herein provides a instrument meeting the needs of a consumer with heightened convenience in accomplishing any one or more certain tasks relative to the functions as already described. In providing such convenience, value is provided to the consumer insofar as the time, effort and expense associated with accomplishing a particular task is reduced; as such, is a value which, it is to be understood, is not to be subordinated by the particular utility offered by the instrument itself.

It is to be noted that the FIGURES depicting the subject matter herein are representative of that subject matter as it has been described and are not meant to limit the range of possible configurations. Those skilled in the art will appreciate that the scope of this subject matter should be measured by the claims appended hereto, and not merely by the specific representations exemplified herein. The references cited are incorporated herein to the extent that they are not inconsistent with the teachings herein.

What is claimed is:

1. A stapler having a first and second sides, and which comprises:
a first arm having a proximal end and a distal end;
a second arm having a proximal end and a distal end, the first and second arms being pivotably connected at the respective proximate ends;
a connecting component associated with said proximal ends of said first and second arm, the connecting component having a perimeter defining a void, the void comprising an opening that communicates with one or both of said first and second sides;
a magnetic component associated with the perimeter so as to exert magnetic force to the void;
a staple depository disposed in one of said first and second arms; and
a staple pad disposed on the arm opposite to the staple depository.

2. The stapler of claim 1, wherein said void is shaped as a circle, oval, triangle, square, rectangle, or hexagon, or another orthogonal shape.

3. The stapler of claim 1, wherein the void is shaped as a circle.

4. The stapler of claim 1, wherein the stapler is configured to balance itself on at least one of said distal ends on the first and second arms.

5. The stapler of claim 4, wherein the first arm, second arm and connecting component form generally a “lambda” shape with the apex of the lambda leaning to the side so as to give the visual effect of the stapler balancing on one end.

6. The stapler of claim 1, wherein said connecting component is a spacer.
